(19) United States
(12) Patent Application Publication
(10) Pub. No.: US 2015/0260310 A1
(43) Pub. Date: Sep. 17, 2015

(54) CHECK VALVE DISC POSITION INDICATOR

(71) Applicant: Yoel Bahalul, Kfar Charuv (IL)

(72) Inventor: Yoel Bahalul, Kfar Charuv (IL)

(21) Appl. No.: 14/210,474

(22) Filed: Mar. 14, 2014

(51) Int. Cl. F16K 37/00

(52) U.S. Cl. CPC F16K 37/0041

(57) ABSTRACT

A check valve assembly includes a check valve including a check valve disc, and a sensor mounted on the check valve disc operative to sense angular positions of the check valve disc.

### CROSS-REFERENCE TO OTHER APPLICATIONS

This application claims priority from U.S. Provisional Patent Application 61/804769, filed Mar. 25, 2013.

### FIELD OF THE INVENTION

The present invention generally relates to check valves, and particularly to a sensor assembly that indicates the angular position of a check valve disc.

### BACKGROUND OF THE INVENTION

There are known check valves with disc-type closure elements pivotally mounted on a shaft for movement between open and closed positions in the valve's flow passage in response to fluid flow through the valve. Such check valves have many uses, such as for line and equipment protection in water and sewage lines. In such check valves, it is important for the line operator to be able to detect the angle of the disc of the check valve at any given time. This information is important in determining proper or improper flow in the system.

In many check valves, where there is an extension of the disc shaft, it is possible to install an electro mechanical limit switch on the disc shaft. However, the limit switch can only sense the extreme limits of the disc angle, that is, either fully opened or fully closed. The limit switch cannot sense angles in between these limits. Thus, if there is any interruption between the two extreme disc positions of fully opened or fully closed, the operator cannot detect the type of failure and is handicapped in determining a solution to the problem.

If there is no rigid shaft connected to the check valve disc that exits the valve body, then one needs to use special types of limit switches and special openings and connectors in the valve body.

Prior art indicators are generally robust and complicated mechanisms installed on or inside the check valve, and the measurement accuracy is limited.

### SUMMARY OF THE INVENTION

The present invention seeks to provide a sensor assembly that indicates the angular position of a check valve disc at all angular positions of the disc, as is described more in detail hereinbelow.

There is thus provided in accordance with an embodiment of the present invention a check valve assembly including a check valve including a check valve disc, and a sensor mounted on the check valve disc operative to sense angular positions of the check valve disc.

### BRIEF DESCRIPTION OF THE DRAWINGS

The present invention will be understood and appreciated more fully from the following detailed description taken in conjunction with the drawings in which:

FIG. 1 is a simplified pictorial illustration of a check valve with sensor and display for showing angular positions of a check valve disc, constructed and operative in accordance with an embodiment of the present invention; and

FIG. 2 is a simplified cutaway illustration of the check valve, showing the sensor that senses the angular positions of the check valve disc.

### DETAILED DESCRIPTION OF EMBODIMENTS

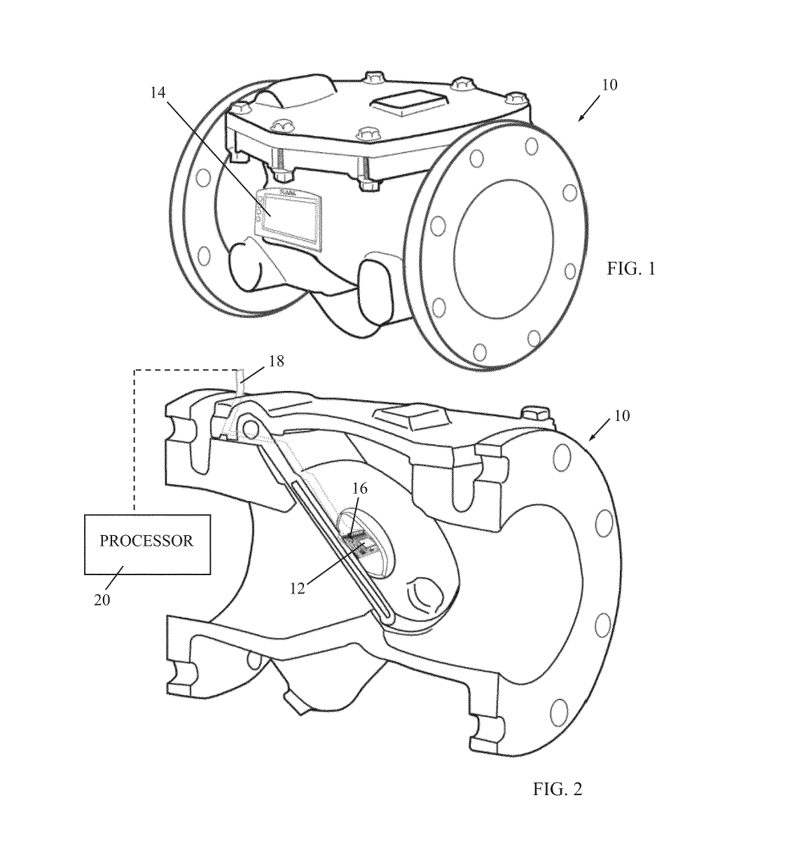

Reference is now made to FIGS. 1 and 2, which illustrate a check valve 10 with a sensor 12 (FIG. 2) and display 14 (FIG. 1) for showing angular positions of a check valve disc 16 (FIG. 2), constructed and operative in accordance with an embodiment of the present invention.

In one embodiment, sensor 12 is a miniature accelerometer or other type of electronic inertia/gravity sensor, such as but not limited to a MEMS component, mounted on the check valve disc 16. Sensor 12 may be in wired communication, by means of a data transfer cable 18, with a processor 20, which may be mounted in check valve 10 or may be remote to check valve 10, such as by wireless communication (e.g., BLUETOOTH, WiFi, GSM\GPRS) or by wired communication. Alternatively, sensor 12 can be in wireless communication of any kind with processor 20. Processor 20 outputs the sensed data to display 14, and may be part of a logic analyzing and presentation unit. The drawings show just one possible installation place and the invention is not limited to this. Processor 20 can additionally or alternatively output the sensed data to a remote user.

Sensor 12 continuously measures the position of disc 16. Sensor 12 can provide real-time measurements continuously in all three mutually orthogonal axes and is easy to adjust, even in place.

Sensor 12 can also be combined with additional sensors such as pressure or temperature sensors, flow sensors or others.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A check valve assembly comprising:
a check valve comprising a check valve disc; and
a sensor mounted on said check valve disc operative to sense angular positions of said check valve disc.

2. The check valve assembly according to claim 1, wherein said sensor comprises a miniature accelerometer or other type of electronic inertia/gravity sensor.

3. The check valve assembly according to claim 1, wherein said sensor comprises a MEMS component mounted on said check valve disc.

4. The check valve assembly according to claim 1, wherein said sensor is in communication with a processor.

5. The check valve assembly according to claim 1, further comprising a temperature sensor.

6. The check valve assembly according to claim 1, further comprising a pressure sensor.

7. The check valve assembly according to claim 1, further comprising a flow sensor.
